(19) United States
(12) Patent Application Publication
(10) Pub. No.: US 2009/0000189 A1
(43) Pub. Date: Jan. 1, 2009

(54) MODULAR PLANTER SYSTEM

(76) Inventor: Alan Black, Scarborough (CA)

Correspondence Address: BERESKIN AND PARR, 40 KING STREET WEST, BOX 401, TORONTO, ON, M5H 3Y2, CA

(21) Appl. No.: 11/768,964

(22) Filed: Jun. 27, 2007

(51) Int. Cl. A01G 25/00

(52) U.S. Cl. 47/82

(57) ABSTRACT

A modular planter system comprises a plurality of vertically spaced apart troughs, at least one longitudinally extending support member adapted to position the troughs one above another, and one or more planter inserts configured for insertion into a trough.

### FIELD OF THE INVENTION

This invention relates to a modular planter system for creating a generally vertical garden for growing plants.

### BACKGROUND OF THE INVENTION

When growing and displaying plants, it is sometimes desirable to arrange the plants in a vertically extending garden. For example, a vertically extending garden may be desired for effectively displaying a number of plants to provide a pleasing or striking display, or to cover a bare wall, fence, or the like. On other occasions it may be desirable to arrange plants vertically for efficiency of growing, for example, to minimize the floor space used or to maximize the plant's exposure to light. Furthermore, it may be desirable for a number of aesthetic or functional reasons to be able to rearrange or replace individual plants or otherwise alter the arrangement of plants.

Several types of modular planters, such as e.g. U.S. Pat. No. 4,561,208 and U.S. Pat. No. 4,896,456 are known. However, these modular planters require each individual plant receptacle to be watered individually, which may be time consuming for a user. Vertical planters that may not require each planter to be individually watered, such as e.g. U.S. Pat. No. 4,380,136 and U.S. Pat. No. 4,614,056, are known. However, one disadvantage with these designs is that they are configured such that water may remove or “wash out” the nutrients from the upper planters towards the lower planters.

A simple construction of a prior art vertical planter is disclosed in U.S. Pat. No. 5,826,375. One disadvantage of this system is that it uses multiple constructions, which may be difficult for some individuals.

### SUMMARY OF THE INVENTION

In accordance with this invention, a vertical planter assembly is provided which utilizes a simplified construction while still permitting all plant containers to be watered by only watering the top plant container.

In addition, the construction facilitates the insertion and removal of the plant containers while reducing, and preferably minimizing, water leaving the planter assembly and, e.g., splashing onto walls, furniture and the like that may be positioned nearby.

In accordance with one aspect of this invention, there is provided a modular planter system comprising:
(a) a plurality of vertically spaced apart troughs, each of said troughs having a top, a bottom, a liquid reservoir, and a drainage conduit having an inlet and an outlet, the inlet in flow communication with an upper portion of the liquid reservoir;
(b) at least one longitudinally extending support member adapted to position the troughs one above another whereby a substantially vertically extending series of troughs is provided;
(c) a plurality of planter inserts, each planter insert is configured for insertion into a trough, each planter insert having a top and a bottom that is received in the reservoir of a trough; and,
(e) the plurality of troughs including at least one pair of adjacent troughs, each pair of adjacent troughs comprising an upper trough and a lower trough, the drainage conduit of the upper trough extending downwardly to a position adjacent the top of a planter insert that is positioned in the lower trough.

In one embodiment, the modular planter system further comprises a flow director positioned to direct liquid exiting the outlet of the drainage conduit of the upper trough away from the inlet of the drainage conduit of the lower trough.

In another embodiment, the flow director forms part of the drainage conduit of the upper trough.

In another embodiment, the flow director comprises an exit aperture portion provided at the outlet of the drainage conduit of the upper trough and configured to direct liquid exiting the outlet at least partially laterally.

In another embodiment, the planter insert positioned in the lower trough includes a wall extending at an angle to the vertical from a position proximate the outlet of the drainage conduit of the upper trough downwardly towards the top of the reservoir of the lower trough.

In another embodiment, the wall terminates at a position proximate the top of the reservoir of the lower trough.

In another embodiment, the flow director forms part of the planter insert positioned in the lower trough.

In another embodiment, the flow director comprises a connecting conduit having an inlet positioned to receive liquid from the drainage conduit of the upper trough and an outlet positioned to direct liquid into the reservoir of the lower trough.

In another embodiment, the flow director comprises an angled wall positioned to receive liquid from the outlet of the drainage conduit of the upper trough, the wall being at an angle to direct the liquid at least partially laterally.

In another embodiment, the planter insert positioned in the lower trough includes a wall extending at an angle to the vertical from a position proximate the angled wall downwardly towards the top of the reservoir of the lower trough.

In another embodiment, the wall terminates at a position proximate the top of the reservoir of the lower trough.

In another embodiment, the flow director comprises a cap positioned over the inlet of a drainage conduit of the lower trough, the cap having at least one sidewall that is at least partially open.

In another embodiment, the flow director forms part of the at least one support member.

In another embodiment, the drainage conduits are centrally positioned.

In another embodiment, the drainage conduits are axially aligned.

In another embodiment, each trough is of the same construction.

In another embodiment, a support member is positioned between each pair of adjacent troughs.

In another embodiment, only one planter insert is received in each trough.

In another embodiment, each planter insert is of the same construction.

In another embodiment, the outlet of the drainage conduit of the upper trough is positioned above the inlet of the drainage conduit of the lower trough.

In another embodiment, the flow director forms part of the liquid reservoir of the lower trough.

In another embodiment, the flow director comprises a cap positioned over the inlet of a drainage conduit of the lower trough, the cap having at least one sidewall that is at least partially open.

In another embodiment, the flow director comprises an angled wall positioned to receive liquid from the outlet of the drainage conduit of the upper trough, the wall being at an angle to direct the liquid at least partially laterally.

In another embodiment, the wall forms part of a recessed channel of the planter insert, wherein the recessed channel is configured to receive the at least one support member when the planter insert is positioned in the reservoir of the trough.

### BRIEF DESCRIPTION OF THE DRAWINGS

These and other advantages of the instant invention will be more fully understood in conjunction with the following description of the following drawings of the preferred embodiments of the invention, in which:

FIG. 1 is a perspective view of a modular planter system of the present invention;

FIG. 2 is a perspective view of a pair of troughs and a support member in accordance with one embodiment of the present invention;

FIG. 3 is a perspective view of a planter insert shown in FIG. 1;

FIG. 4 is a side plan view of the modular planter system of FIG. 1 showing a planter insert removed from the modular planter system;

FIG. 5 is an exploded view of a trough, planter insert and support member of FIGS. 2 and 3.

FIG. 6 is a cross-sectional elevational view along the line A-A in FIG. 5;

FIG. 7 is a cut away view of a second embodiment of the modular planter system of the present invention;

FIG. 8 is a cross-sectional elevational view of the modular planter system of FIG. 7 exemplifying the water flow path;

FIG. 9 is a cross-sectional elevational view of a third embodiment of the modular planter system of the present invention;

FIG. 10 is a cross-sectional elevational view of fourth embodiment of the modular planter system of the present invention;

FIG. 11 is a perspective view of another embodiment according to this invention wherein the modular planter system is hung from a wall; and,

FIG. 12 is a cross section of the modular planter system of FIG. 11.

For simplicity and clarity of illustration, elements shown in the figures have not necessarily been drawn to scale. Further, where considered appropriate, reference numerals have been repeated among the figures to indicate corresponding or analogous elements.

### DETAILED DESCRIPTION OF THE PREFERRED EMBODIMENTS

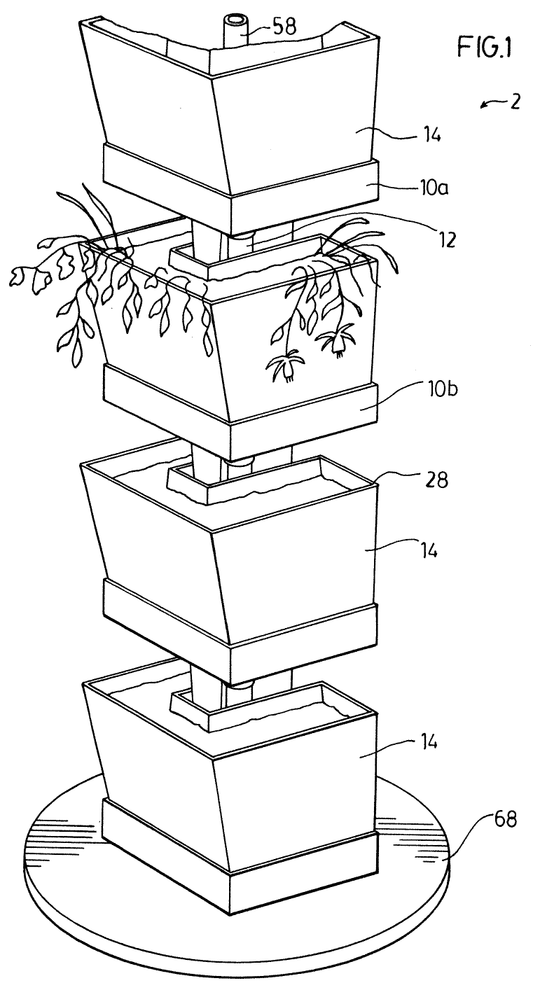

Reference is first made to FIG. 1, which illustrates a modular planter system 2 in accordance with a preferred embodiment of the present invention. As shown, a modular planter system 2 comprises a plurality of troughs 10 positioned one above another, such as by at least one longitudinally extending support member 12, and a plurality of planter inserts 14 positioned in the troughs 10. For the purpose of explaining the assembly, reference will be made to a pair of vertically adjacent troughs 10, comprising an upper trough 10a and a lower trough 10b.

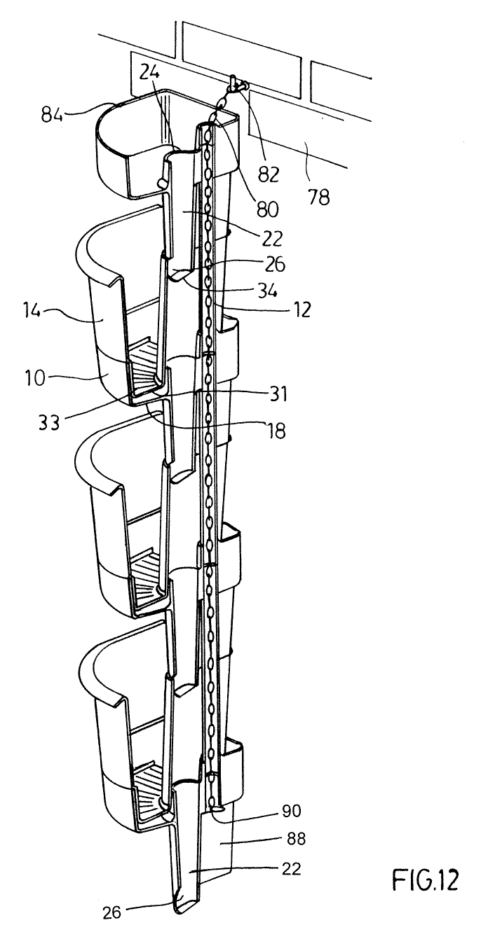

The planter system 2 may comprise a base or floor stand 68 to aid in positioning or stabilizing the system 2 on the floor or other surface load bearing surface, such as a table or a shelf mounted to a wall (see for example FIG. 1). Alternately, or in addition, the planter system 2 may comprise a hanging means for supporting the planter system 2 above the floor (see for example FIGS. 11 and 12). Alternatively, the planter system 2 may be mounted, for example, to a wall, if desired. As exemplified in FIGS. 11 and 12, the planter system 2 may be hung from a wall. Furthermore, it will be appreciate that the components of the planter system 2 may be assembled from a kit, where the individual components have a size and weight such that an individual user may easily handle them.

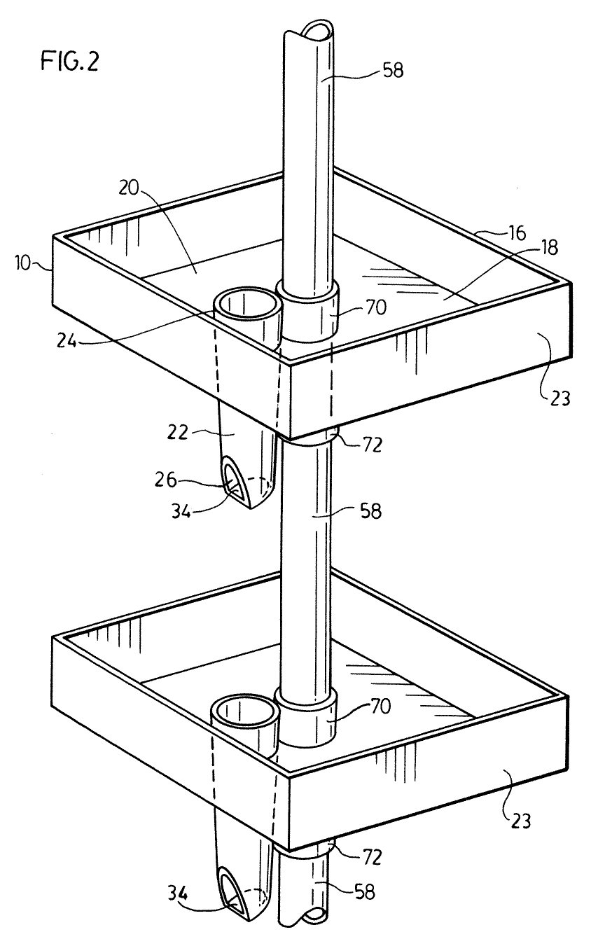

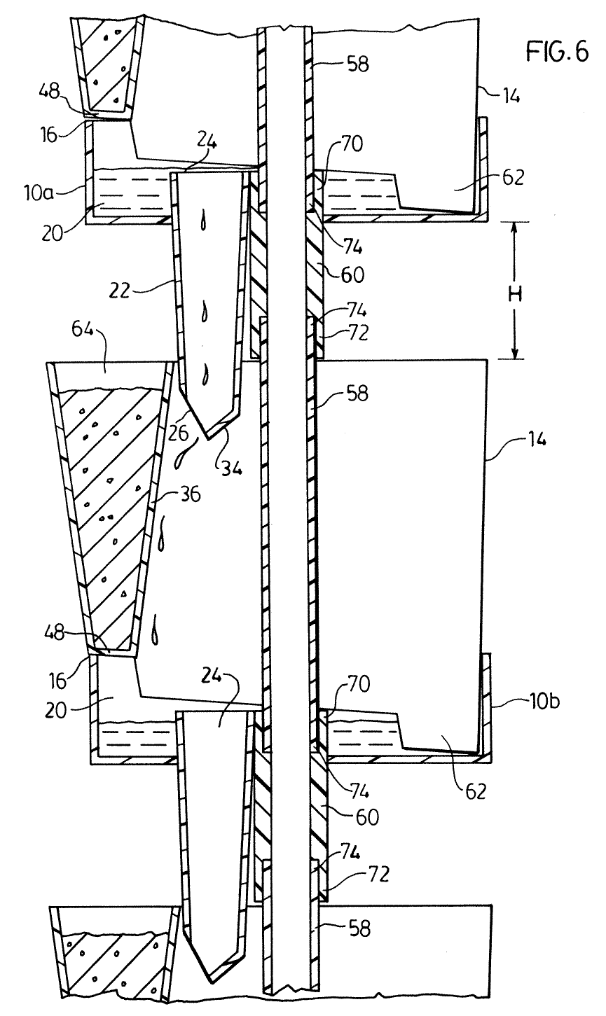

Referring now to FIGS. 2, 3, 4, 5 and 6 there is shown components of a modular planter system 2 in further detail in accordance with one embodiment of the present invention. At least one longitudinally extending support member 12 positions the troughs 10 one above the other to form a substantially vertically extending series of troughs 10. Support member 12 serves as connecting means between troughs 10 and may comprise a single pole extending through each trough 10 and lockingly engaging each trough 10 to maintain the relative position of each trough 10 in the assembled planter system 2. Preferably, as exemplified, support member 12 comprises a plurality of rods 58 that extend between adjacent troughs 10. Each trough 10 has a central hub 10 having an upper end 70 and a lower end 72 (see FIG. 6). Rod 58 is connected with the central hub 60 to provide a continuously extending support member 12 that positions the upper trough 10 above the lower trough 10, as shown in FIG. 2, 4 and 5.

The vertically extending members may be hollow, or may be solid. When the modular planter system is assembled, the vertically extending members will comprise a continuously extending support member 12 for positioning troughs 10 at a desired vertical spacing.

The vertically extending members may be connected together by any means known in the art. In one embodiment of the present invention, the support members may be connected by means of male-female engagement means. As exemplified in this embodiment, each end 70, 72 has a cavity 76 having an inner diameter sized to receive an end of rod 58. Accordingly, each end 74 of rod 58 may be a male member sized to be received in cavity 76 of female upper end 70 and lower end 72 of central hub 60. Male rod 58 is a smaller tube than female central hub 60 so as to be received therein. Preferably, rod 58 is lockingly received in central hub 58, such a by a friction or interference fit. However, any attachment means known in the art may be used such as mechanical attachment means (e.g., a screw or bayonet mount) or an adhesive.

In another embodiment, male and female ends 58 and 60 may be provided with aligned apertures which are adapted to receive a locking pin to securely lock mated vertically extending members together and to ensure that the attached troughs are fixed in a desired relationship (not shown). Other suitable connection means known in the art that may be used include mating threads, spring clip fasteners and set screws.

The vertically extending members are preferably of a sufficient length to space each trough 10 a pre-selected distance below the bottom of the next higher trough 10 so as to provide an open vertically extending area of sufficient height H to accommodate the growth of a plant situated within a planter insert 14. It will be appreciated that rods 58 of varying lengths may be provided as part of a kit so that a user of the modular planter system may modify the height between adjacent vertically spaced apart troughs 10a, 10b by selecting a rod 58 of the desired length.

Central hub 60 may be hollow and is preferably integrally molded as part of trough 10 to provide a watertight joint between central hub 60 and trough 10. It will be appreciated that in other embodiments of the invention rod 58 may be secured to and extend from longitudinally extending sides of trough 10. Alternately, troughs 10 and central hub 60 may be constructed separately, and later assembled by, for example, a screw thread relationship or a seated relationship in combination and/or with an adhesive means.

As shown in FIG. 2, each trough 10 has a top 16, a bottom 18, side walls 23 extending up from bottom 18 to define a volume defining a liquid reservoir 20, and a drainage conduit 22. Trough 10 is sized to receive one or more planter inserts 14, and preferably one planter insert as exemplified in FIG. 1. The trough 10 contains a liquid reservoir 20, which may be defined as the volume within the trough 10 above bottom 18, below inlet 24 of drainage conduit 22, and between sides 23 of the trough 10. It will be appreciated that the trough 10 and reservoir 20 may be of any dimension, size or shape, so long as one or more planter inserts 14 may be received in the reservoir 20 of the trough 10. For example, the sides of the trough 10 may extend upward vertically or at an angle to the vertical and the perimeter of bottom 12 may be square, round or any desired shape.

Each trough 10 includes a drainage conduit 22 with an inlet 24 (i.e. aperture) in flow communication with the upper portion of the reservoir 20 due to the drainage conduit 22 protruding upwards into the liquid reservoir 20. As such, the upper portion of the reservoir 20 is the portion at about the height of inlet 24.

Drainage conduit 22 may be integrally formed with trough 10 or it may be individually constructed and lockingly inserted into trough 10 such as by means of a fluid impermeable adhesive or the like. Drainage conduit 22 may be of any dimension, size or shape, so long as it functions as a conduit. When the level of liquid and/or other materials in the reservoir 20 of upper trough 10a rises above inlet 24 of drainage conduit 22, liquid and/or other materials will flow into inlet 24, downwardly through drainage conduit 22 and out through outlet 26.

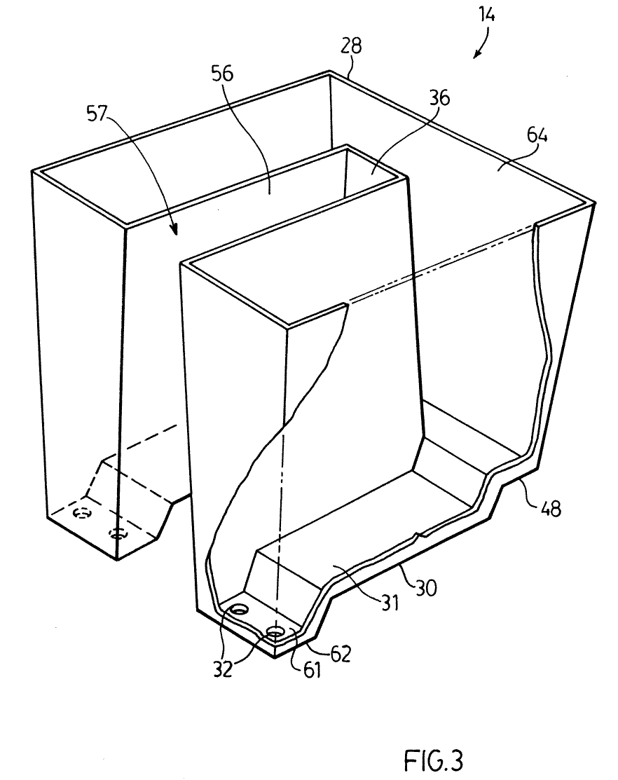

The modular planter system 2 further includes planter inserts 14 shaped to be positioned within a trough 10, where an exemplary embodiment is shown in FIG. 3. Each trough 10 is accordingly sized to receive at least one planter insert 14. Planter insert 14 has a top 28 and a bottom 30 and in this instance has a cube-like shape so that it may be positioned within a trough 10. It will be appreciated that the planter insert 14 may take the shape of any suitable planter insert 14 known in the art so long as at least one may be positioned within a reservoir 20 of a trough 10. The planter insert 14 has a plant-receiving portion 64 for containing a plant, growth medium (e.g. soil, peat, sand), seeds, and the like in accordance with any planting practice. Moreover, each planter insert 14 has at least one aperture 32 in flow communication with the reservoir 20 of the trough 10 it is positioned within. It will be appreciated that the height of reservoir 20 is sufficient such that aperture 32 is positioned within the reservoir 20.

The modular planter system 2 may optionally comprise locking means for securing, and preferably releasably securing, planter inserts 14 within troughs 10 (not shown). For example, the locking means may comprise male and female engagements means. Preferably, one or more planter inserts 14 are removably received by a trough 10, so that planter inserts 14 may be easily moved to a different position within trough 10 or to a different trough 10, if it is desirable to rearrange the plants within planter system 2 without removing the trough 10 or uprooting the plant from planter insert 14. It will be appreciated that if more than one planter insert is received in a trough 10, then the planter inserts 14 may interconnect.

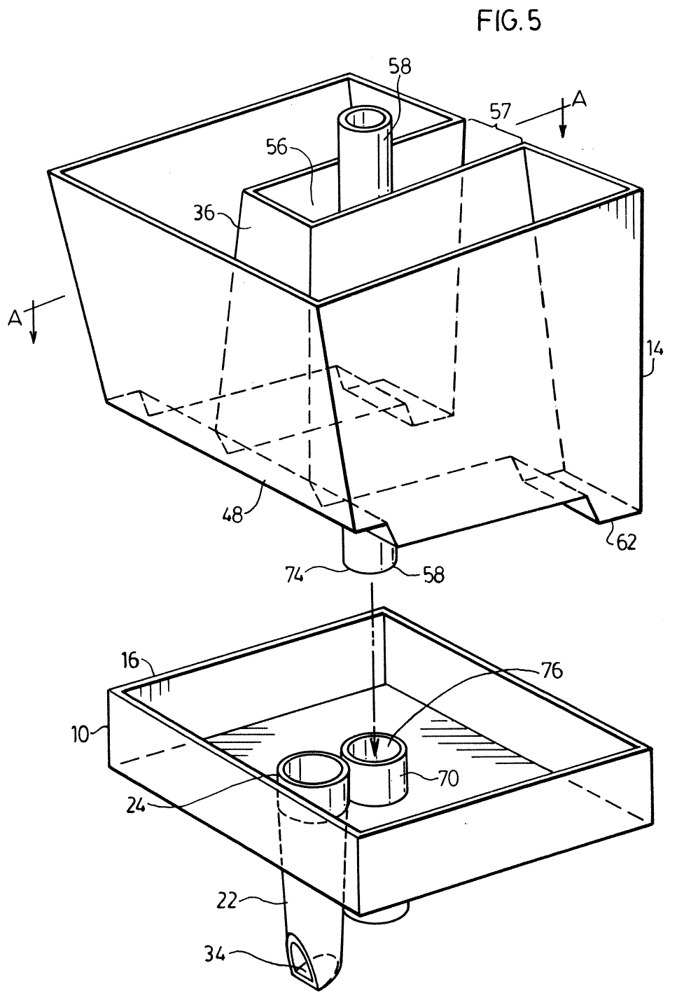

If support member 12 extends through a volume in which planter 14 will be received, then planter insert 14 may have a recessed channel 56 through which support member 12 may pass. As exemplified in FIG. 3, recessed channel 56 is U shaped and has an open end 57. Open end 57 permits planter insert 14 to be inserted into trough 10. Once inserted, planter insert substantially surrounds rod 58. As exemplified in FIG. 3, the recessed channel 56 gives the planter insert 14 a three-dimensional U-shape configuration. In FIGS. 3 and 5, the recessed channel 56 is located in the center of the planter insert 14 so as to receive a centrally located support member 12.

It will be appreciated that if more than one planter insert 14 is provided in a trough 10, then a recessed channel may not be required as planter inserts 14 may be configured to leave an open volume for rod 58 or two or more planter inserts 58 may define a recessed channel 56 for rod 58.

It will be appreciated that the recessed channel 56 may be positioned to the right or left of the center axis of planter insert 14 to accommodate various positions of the support member 14, and may have various dimensions and shapes depending on the size and shape of the support member 12. The recessed channel 56 gives the plant receiving portion 64 of the planter insert 14 a three-dimensional U-shape configuration. A cross-sectional view taken along line A-A of FIG. 3 of a plant-receiving portion 64 of a planter insert 14 is shown in FIG. 6.

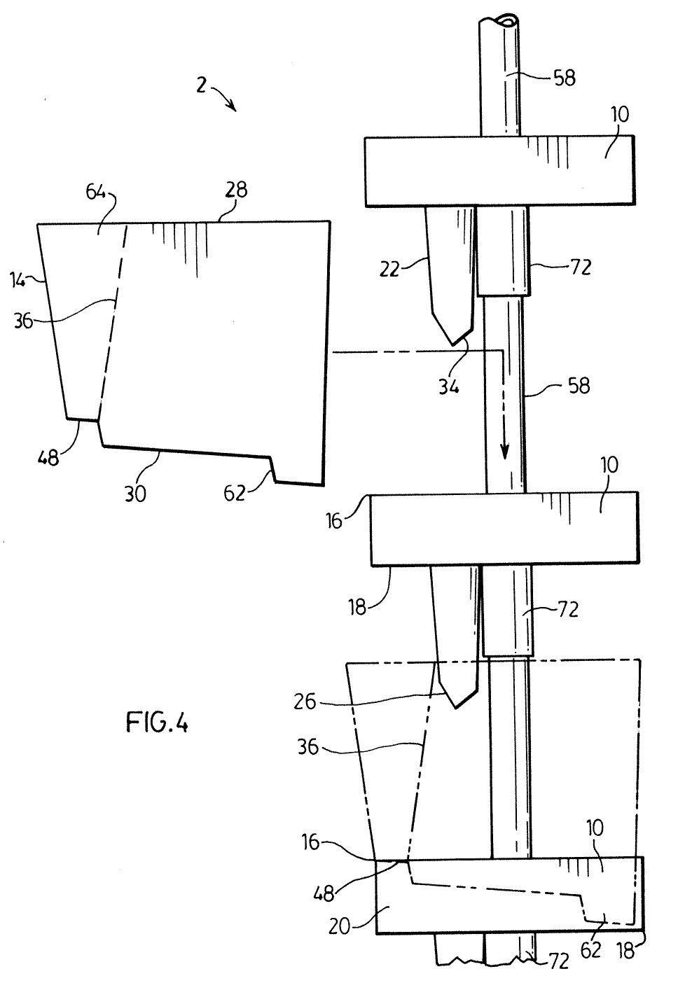

When the planter insert 14 is positioned in a lower trough 10b, the bottom 30 is positioned within the reservoir 20 of the lower trough 10b while the top 28 of the planter insert 14 is below the bottom 18 of upper trough 10a. The bottom 30 of planter insert 14 may be of any desired configuration. For example, bottom 30 may be planar (horizontal) Alternately, as exemplified in FIGS. 3-6, bottom 30 may have a lower portion 62 in which drainage apertures 32 are provided, so that when planter insert 14 is positioned within trough 10 lower portion 62 rests on the bottom 18 of the trough 10, or more specifically the bottom of the liquid reservoir 20, as shown in FIG. 4. When liquid and/or other materials is provided to a reservoir 20 of a trough 10 containing a planter insert 14 with a plant and growth medium (e.g. soil, peat and/or sand) in the plant receiving portion 64, the liquid may be absorbed into the plant and growth medium via apertures 32. The planter insert 14 may be solid, mesh-like or a combination of solid and mesh-like. It will be appreciated that using mesh-like material to make all or part of the planter insert 14 may facilitate the circulation of air or liquids to a plant contained therein. An advantage of lower portion 62 is that only part of bottom 30 may be within reservoir 20.

If a lower portion 62 is provided, then planter 14 is preferably provided with a member or members to stabilize planter insert 14 within reservoir 10. For example, bottom 30 may also have a horizontally extending lip 48 positioned such that when planter insert 14 is positioned within trough 10, lip 48 at least partially rests on or contacts the top 16 of trough 10. The bottom of lower portion 62 and lip 48 of the planter insert 14 create feet to support planter 14 in trough 10, as shown in FIG. 4. The planter insert 14 may have more than one extending lower portion 62 or none at all, and lower portion 62 may have a rectangular shape, an elliptical shape or any other suitable shape. Moreover, the planter insert 14 may have more than one lip 48 or none at all, and the lip 48 may also take a variety of shapes.

It will be appreciated that apertures 32 may be located in various places on bottom portion 30 of planter insert 14, such as along the side walls or along the floor (e.g. as shown in FIG. 3), so long as liquid contained within the reservoir 20 may be absorbed through the apertures 32. It will be appreciated that all or a portion of bottom 30 may be an open web or the like thereby defining a plurality of apertures 32. It will be appreciated that liquid and other materials in reservoir 20 may be taken up into the plant and growth medium (e.g. soil) by, for example, absorption, adsorption or capillary action. Alternatively or additionally, plant roots can extend into reservoir 20 to directly feed from the liquid in the reservoir 20.

Alternately, lower portion 62 and horizontal lip 48 may be sized so as to position lower surface 31 above the maximum depth of reservoir 20. For example, lower portion 62 may have a vertical extent between lower surface 31 and bottom 61 of lower portion 62 that is longer than the height of inlet 24 above bottom 18 of trough 10. Accordingly, lower surface 31 is positioned above the water in reservoir 20 at all times. In this embodiment, lower surface 31 may be provided with openings 33 to provide an inlet for air into the soil or the like in the planter insert 14 (see for example FIG. 12).

An exemplary embodiment of an assembled modular planter system 2 is shown in FIG. 4. Rods 58 position a series of vertically extending troughs 10, each of which have a drainage conduit 22, such that outlet 26 of upper trough 10a is positioned adjacent the top 28 of a planter insert 14 positioned within a lower trough 10b. The inlet 24 of the drainage conduit 22 is in liquid communication with an upper portion of the reservoir 20 (e.g. see FIG. 2) so that when the level of liquid and/or other materials in the reservoir 20 of an upper trough 10 rises above inlet 24 of drainage conduit 22, liquid and/or other materials will flow into inlet 24, downwardly through drainage conduit 22 and out through outlet 26 to a position adjacent top 28 of the planter insert 14 of lower trough 10b. The liquid will collect in reservoir 20 of lower trough 10 so that it can be taken up into the plant via apertures 32 in the bottom 30 of the planter insert 14.

An advantage of channeling overflowing liquid (i.e. liquid that rises above the inlet 24 of the drainage conduit 22) to the reservoir 20 of a lower trough 10 is that a user can provide liquid to an upper trough 10a and the liquid will be sequentially distributed to lower troughs 10b via the conduits 22 if sufficient liquid is provided. This configuration allows the user to water all plants contained in planter inserts 14 positioned in lower troughs 10b by only providing a sufficient amount of liquid and/or other materials to an upper trough 10a. Preferably liquid and/or other materials are provided to the uppermost trough 10 and, assuming a sufficient amount of liquid is provided, liquid will be evenly distributed to all lower troughs 10b. Liquid and other materials may be added to an upper trough 10a using any means known in the art, such as by a hose, a watering can or a pump with regulator means. Moreover, it will be appreciated that this sequential distribution of liquid may be suitable for use with a hydroponic growth system in which a liquid and/or nutrient is continuously circulated throughout the system, thus supplying plants with a consistent and even distribution of nutrients.

The outlet 26 of conduit 22 extends proximal to the top 28 of the planter insert 14 and optionally into an upper portion of the recessed channel 56, if provided. In this configuration liquid and/or materials flowing out of the outlet 26 may flow directly into the reservoir 20 of the lower trough 10, in between the recessed channel 56 of the planter insert 14 positioned within the reservoir 20 of the lower trough 10. Accordingly, liquid and other materials may not drain directly onto the plants and the growth medium (e.g. soil, peat and/or sand) in the planter inserts 14 in the next lower trough 10. Instead, liquid and materials that flow into reservoir 20 may be taken up into plants and, e.g., soil via apertures 32 in the bottom 30 of the planter insert 14.

An advantage to channeling overflow liquid and other materials from an upper trough 10a to the upper portion of the planter insert 14 (in particular the upper portion of the recessed channel 56) and into the reservoir 20 of the next lower trough 10b is that liquid and other materials will be distributed more evenly along the length of the next lower trough 10b and consequently, will be distributed more evenly among the various plants in planter inserts 14 in the next lower trough 10b. In contrast, if the liquid and other material flowed from the drainage conduit 22 into a planter insert 14, the user would have to wait for the water to drain through planter insert 14 prior to filling reservoir 20 and overflowing to the next lower planter insert 14.

In accordance with a further aspect of the present invention, all troughs 10 may have the same construction, e.g. have a substantially similar size, a substantially similar shape, with the support member 12 and drainage conduit 22 positioned in substantially the same place. However, it will be appreciated that in some embodiments the troughs 10 may have different constructions. FIG. 4 illustrates a cross-sectional view of the modular planter system 2 wherein each trough 10 is the same and with drainage conduit 22 provided in a central portion of trough 10. Moreover, central hub 60 is centrally located such that a single rod 12 may extend through all troughs 10 so as to provide an aligned vertically extending series of troughs 10. In some embodiments, each trough 10 may be sized to receive only one planter insert 14, however a trough 10 may also receive a plurality of planter inserts 14. Preferably, each planter insert 14 may have the same construction. Accordingly, planter system may be provided as a kit having a number of identical troughs, thereby simplifying the construction of the system. A consumer may insert a rod 58 into a central hub 60 of a trough 10 without concern about the alignment or orientation of trough 10.

Troughs 10 and planter inserts 14 may be molded from a lightweight, high strength plastic, which may be flexible. Alternatively, the components of the system 2 could be made from other materials, for example other moldable polymers or from metal or fiberglass.

A further advantage in having individual components of the planter system 2, such as troughs 10 and planter inserts 14, of the same construction is that manufacturing and replacement costs may be reduced. For example, each component may be manufactured using the same sub-components, molds, etc. and a user may easily replace or add a component without considering whether a specific model is necessary. For example, the user does not have to consider a specific trough model relating to a specific size or shape of a trough 10 or a trough 10 model with a specific alignment of the drainage conduit 22.

Preferably, the drainage conduits 22 are positioned adjacent central hub 60 such that, when system 2 is assembled, conduits 22 are axially aligned one above the other. That is, the outlet 26 of the drainage conduit 22 of an upper trough 10a is positioned above the inlet 24 of the drainage conduit 22 of a lower trough 10b so that the conduits 22 are aligned along the same vertical axis. Axially aligning the drainage conduits permit planter inserts 14 to be inserted from the same side of system 2. In an embodiment where all troughs 10 have the drainage conduit 22 in substantially the same place, then assembly may be simplified as a user simply positions the troughs 10 one above the other and will be guided by the alignment of the drainage conduits 22 of each trough 10, without having to consider whether the drainage conduits 22 should be positioned according to an alternating pattern.

However, axially aligning the drainage conduits 22 may pose some problems when the planter system 2 is in operation. For example, liquid flowing out the outlet 26 of the drainage conduit 22 of an upper trough 10a may flow directly into the inlet 24 of the drainage conduit 22 of a lower trough 10b before allowing the liquid to at least partially fill the reservoir 20 of the lower trough 10b and be absorbed by plants in the planter inserts 14 of the lower trough 10b. Accordingly, in accordance with this embodiment of the invention, there is preferably provided a flow director. The flow director directs the flow of liquid and materials exiting the outlet 26 of conduit 22 of an upper trough 10a away from the inlet 24 of the conduit 22 of the next lower trough 10b.

The flow director may form part of the drainage conduit 22 of the upper trough 10a. For example, as exemplified in FIG. 6, the flow director forms part of the drainage conduit 22, and in particular comprises an exit aperture portion 34 provided at the outlet 26 of the drainage conduit 22. The exit aperture portion 34 may have the shape of a diagonal lip, as shown, so as to direct liquid exiting the outlet 26 at least partially laterally. It will be appreciated that the exit aperture portion 34 may have various configurations so long as it functions to direct the liquid exiting the outlet 26 of the conduit 22 at least partially laterally. Moreover, the exit aperture portion 34 may be integrally attached to the outlet 26 of the drainage conduit 22 or may be releasably or lockingly attached such that the exit aperture portion 34 is an add-on component to a drainage conduit 22, using any suitable attachment means known in the art.

As an additional aid for directing the flow of liquid exiting the outlet 26 of drainage conduit 22 of the upper trough 10, the planter insert 14 positioned in the lower trough 10 may include an angled wall 36. As shown, the angled wall 36 extends at an angle to the vertical from a position proximal to the outlet 26 of the drainage conduit 22 of the upper trough 10a and extends downward towards the top 16 of the reservoir 20 of the lower trough 10b, in order to guide the directed liquid into the reservoir 20 of the lower trough 10b or to prevent liquid exiting outlet 26 of the upper trough 10a from splashing out of the planter system 2. Referring back to FIGS. 3, 4 and 5 the configuration of a planter insert 14 with an angled wall 36 is shown in various perspectives. The planter insert 14 has a recessed channel 56 so that the planter insert has a three dimensional U-shape configuration which forms a plant receiving portion 64. The angled wall 36 provides for one wall of the recessed channel 56, so that when the rod 58 and central hub 60 of support member 12 are connected and the planter insert 14 is positioned within trough 10, the recessed channel 56 receives the support member 12 and may be aligned over the outlet 26 of the drainage conduit 22 of the trough 10.

FIG. 6 illustrates a cross-sectional view of a modular planter system at approximately line A-A of FIG. 3, and further includes additional troughs 10 and planter inserts 14. Moreover, a cross-sectional view of the plant-receiving portion 64 of the planter insert 14 is shown to contain growth medium (e.g. soil, peat and/or sand) and perhaps seeds or the like. The outlet 26 of the drainage conduit 22 of the upper trough 10a with the exit aperture portion 34 attached thereto protrudes into an upper portion of the recessed channel 56 of the planter insert 14 positioned in the lower trough 10b. In operation, overflowing liquid and/or materials flow into the inlet 24 of the upper trough 10a, through the drainage conduit 22 and exits via the outlet 26. The exit aperture portion 34 includes a diagonal lip or angled spout, which directs liquid at least partially laterally away from the inlet 24 of the conduit 22 in the lower trough 10 and towards the angled wall 36 of the planter insert 14. The angled wall 36 is positioned close to the outlet 26 of the conduit 22 and extends downwardly and outwardly, ending near the top 16 of the lower trough 10b. In this configuration the angled wall 36 may help prevent liquid directed laterally by the exit aperture portion 34 from splashing out of the trough lower 10b and guides the liquid into the reservoir 20 of a lower trough 10b, so that it may be taken up into the plant and growth medium through apertures 32 in the planter insert 14. It will be appreciated that, without exit aperture portion 34, some or all of the liquid would fall downwardly from outlet 26 and enter inlet 24 of the next lower trough 10b, thereby bypassing reservoir 20. Accordingly, reservoir 20 may not receive sufficient water so as to water plants in planter insert 14 located in lower trough 10b.

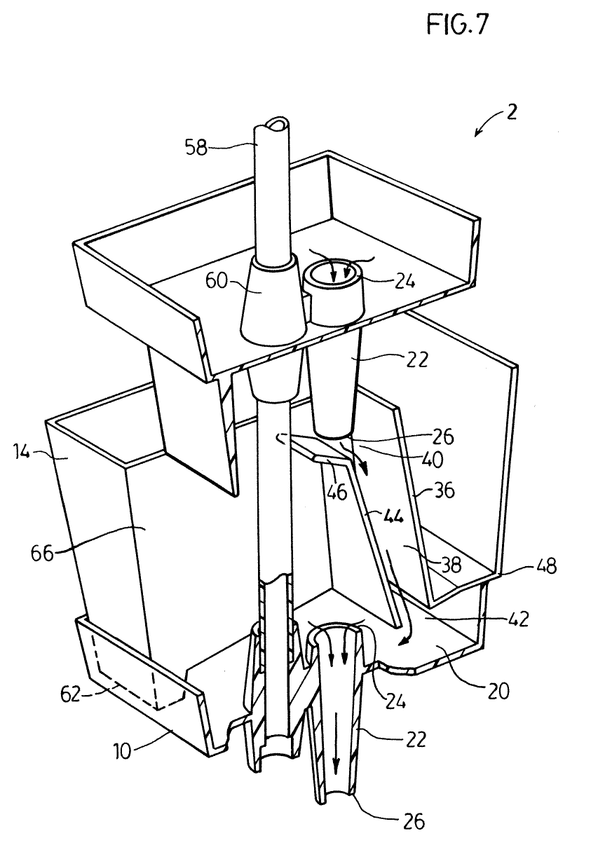

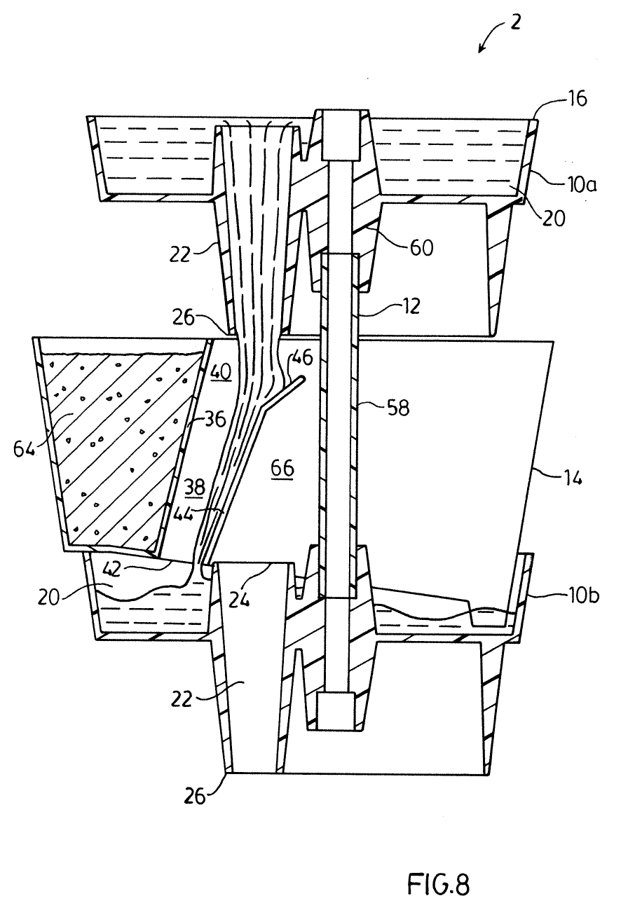

Alternately, or in addition, the flow director may form part of the planter insert 14 positioned in the lower trough 10b. For example, the flow director may comprise a connecting conduit 38, as shown in FIGS. 7 and 8. The connecting conduit 38 may be formed by angled wall 36 of the planter insert 14 and a second wall 44, that is preferably also angled, that may be attached to an inner wall 66 of the recessed channel 56 of the planter insert 14. The angled wall 44 may be integrally attached or releasably attached to the inner wall 66 using any suitable means known in the art, such as glue or mechanical means. The angled wall 44 is positioned to receive liquid exiting the outlet 26 of the conduit 22 of the upper trough 10a. The wall 44 extends at an angle to direct the liquid at least partially laterally so as to reduce and preferably prevent the liquid from flowing directly into the inlet 24 of conduit 22 of lower trough 10b as the wall 44 may extend at an angle away from the inlet 24 and end near the top 16 of the lower trough 10b beside the inlet 24, so that the wall 44 is situated between the flow of liquid and the inlet 24.

The connecting conduit 38 has an inlet 40 in a position to receive liquid exiting the outlet 26 of the drainage conduit 22 of the upper trough 10, and an outlet 42 in a position to direct liquid into the reservoir 20 of the lower trough 10b, but not directly into inlet 24 of conduit 22 of lower trough 10b. In this arrangement, the inlet 40 and outlet 42 of the connecting conduit 38 are provided by the two angled walls 36 and 44 and the connecting conduit 38 extends to a position near the top 16 of trough. However, it will be appreciated that the connecting conduit 38, inlet 40 and outlet 42 may have various shapes and configurations so long as they function together to provide a conduit. Moreover, the connecting conduit 38 may be integrally, lockingly or releasably attached to the conduit 22 of an upper trough 10 (not shown), instead of being attached to the planter insert 14.

In some embodiments, an angled flange 46 may be connected to the top of wall 44 and/or attached to an inner wall 66 of the recessed channel 56 of the planter insert 14, to form the connecting conduit together with the angled wall 36 of the planter insert 14. The angled flange 46 may extend at a greater angle to the vertical than the angled wall 44 so as to direct the flow of liquid at least partially laterally, away from the inlet 24 of the conduit 22 of the lower trough 10b. Alternatively, the planter insert 14 may not include wall 44 that extends all the way to reservoir 20 of lower trough 10b, and instead the angled flange 46 and the angled wall 36 alone provide for the connecting conduit 38. In such an embodiment, the connecting conduit 38 does not extend all the way to the top 16 of a lower trough, and may extend to any position where its outlet 42 is positioned to direct liquid into the reservoir 20 of a lower trough 10b at a position that is not directly above inlet 24 of conduit 22 of lower trough 10b. In any embodiment, angled flange 46 may extend at any angle sufficient to direct the flow of liquid exiting an outlet 26 of the conduit 22 of an upper trough at least partially laterally. It will be appreciated that the angled flange 46 may be integrally attached or releasable attached to the planter insert 14, using any suitable attachment means known in the art.

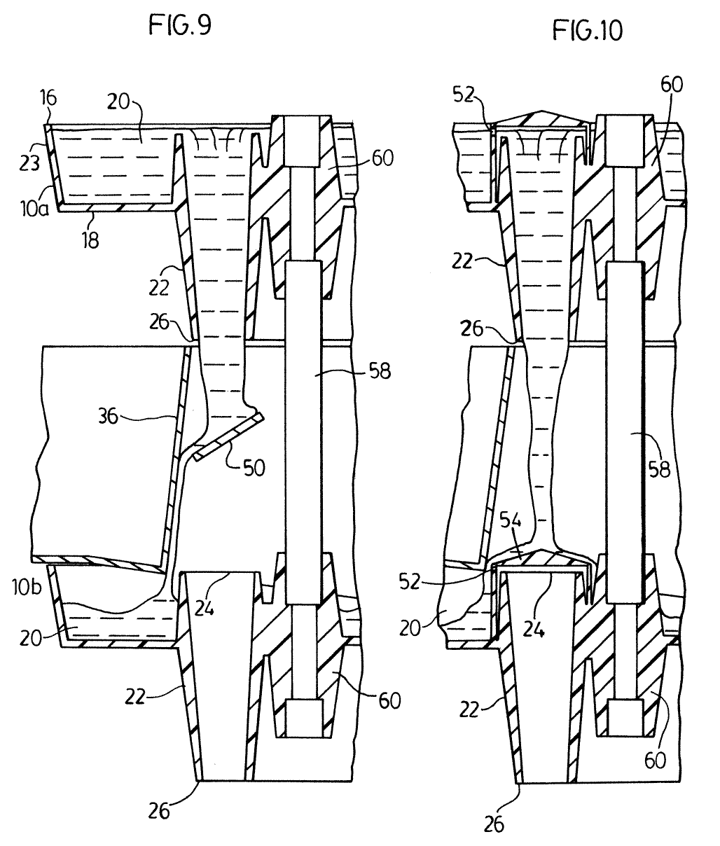

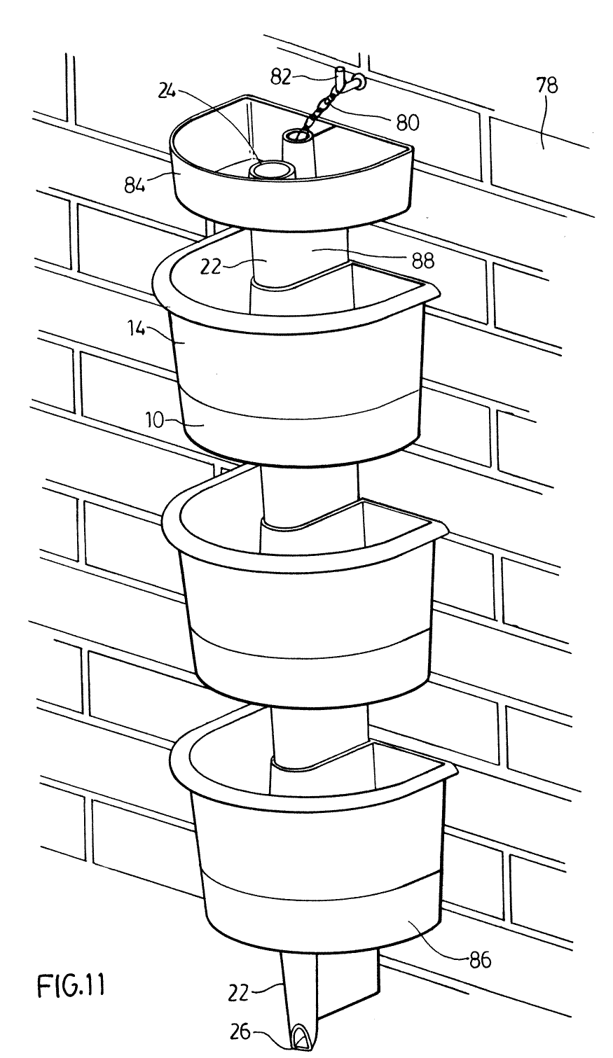

Alternately, the flow director may comprise a deflector flange 50, as shown in FIG. 9. This alternate embodiment may be used alone or in conjunction with the embodiments of FIGS. 6 or 10. The deflector flange 50 may be attached to the inner wall 66 of the recessed channel 56 of the planter insert 14 or rod 58, in a position to direct liquid exiting the outlet 26 of the conduit 22 of the upper trough 10a away from inlet 24 of lower trough 10b. The deflector flange 50 extends at an angle to the vertical to direct received liquid at least partially laterally, towards the wall 36 of the planter insert 14 and into the reservoir 20 of the lower trough 10. The deflector flange 50 may be aligned above the inlet 24 of the conduit 22 of the lower trough 10b, so as to shield or deflect the flow of liquid away from the inlet 24. It will be appreciated that the deflector flange 50 may be integrally, releasably or lockingly attached to the planter insert 14, using any suitable attachment means known in the art.

Alternately, or in addition, the flow director may comprise a cap 54 positioned over the inlet 24 of the conduit 22 of the lower trough 10b, as exemplified in FIG. 10. The cap 54 deflects liquid in order to prevent the liquid from flowing directly from the outlet 26 of the conduit 22 of the upper trough 10a into the inlet 24 of the conduit 22 of the lower trough 10b. The top of the cap 54 may have the shape of a wedge, so that liquid flowing from the outlet 26 of the upper trough's 10 conduit 22 is directed to either side of the inlet 24. The cap may also have one or more sidewalls positioned to the side of the inlet 24, where one sidewall of the cap 54 is at least partially open so as to provide an opening 52, so that liquid in reservoir 20 of the lower trough 10 may enter through the opening 52 and into the inlet 24. Moreover, the top of the cap 54 is positioned sufficiently above the inlet 24 of the conduit 22 so as to allow liquid to enter inlet 24.

The cap 54 may be attached to the inner wall 66 of the recessed channel 56 of the planter insert 14 or rod 58, so that when the planter insert 14 is inserted into the lower trough 10b, the cap 54 is aligned over the inlet 24, but is positioned sufficiently above the inlet 24 so as to provide an opening 52. It will be appreciated that the cap may have various configurations, so long as it is positioned over the inlet 24 of the drainage conduit 22 of a lower trough 10b and has at least one side wall with an opening 52 so that liquid in the reservoir 20 of the lower trough 10b may enter the inlet 24. Moreover, the cap 54 may be integrally lockingly, or releasably attached to a component of an existing planter system as an add-on component.

In accordance with a further aspect of the present invention the flow director forms part of the support member 12. For example, the angled flange 46 and/or wall 44 may not be attached to the inner wall 66 of the recessed channel 56 and may instead be connected to the support member 12. One end of the angled flange 46 may be connected to the wall 44 while the other end extends to the support member 12 and is attached thereto (not shown), using any suitable means known in the art such as glue or locking means. The angled flange may also be releasably connected to the support member 12. When the planter insert 14 is positioned in the lower trough 10 its inner wall 36 together with the angled flanged 46 and wall 44 provide the connecting conduit 38. As another example, the deflector flange 50 shown in FIG. 9 may not be attached to the inner wall 66 of the recessed channel 56 of the planter insert 14, and may instead be connected to the support member 12 (not shown). In such an embodiment, the deflector flange 50 extends from the support member 12 at an angle so as to direct the flow of liquid partially laterally towards the wall 36 of the planter insert 14 and into the reservoir 20 of the lower trough 10. As a further example, the cap 54 may not be attached to the planter insert 14, and may instead be attached to the support member 12 and/or lower trough 10b, wherein at least one opening 52 is provided in the sidewall of the cap 54 so as to allow liquid in reservoir 20 to enter inlet 24 of conduit 22 of the lower trough 10b. The cap 54 may be attached to the support member 12 or lower trough 10b using any suitable attachment means known in the art such as glue or a releasable locking attachment means.

In accordance with a further aspect of the present invention the flow director forms part of the liquid reservoir 20 of the lower trough 10b. For example, part of the cap 54 may be attached to the bottom 118 of liquid reservoir 20 of the lower trough 10b, such as the bottom of the at least one sidewall of the cap 54. The cap is attached to the liquid reservoir 20 such that at least one opening 52 is provided in a sidewall of the cap 54 so as to allow liquid in reservoir 20 to enter inlet 24 of conduit 22 of the lower trough 10b. The cap 54 may be attached to the liquid reservoir 12 using any suitable attachment means known in the art such as glue or a releasable locking attachment means.

As exemplified in FIGS. 11 and 12, planter system 2 is suspended from wall 78 by a chain 80 mounted on a hook 82 that extends through support members 12 and is configured to retain the planter system in an assembled state, such as by having a member secured at the end of chain 80 distal to hook 82, which member has a larger diameter than support member 12 so as not to be capable of passing therethrough, or by securing the distal end of chain 80 in position, such as by securing it to retaining member 90, or by any other means known in the art. It will be appreciated that hook 82 may be mounted on any wall surface or a ceiling and may be of any hanging support that provides a position on which chain 80 (or any rope or other flexible elongate member) may be mounted. It will be appreciated that a flexible support member such as chain 80 may be used alone or in conjunction with a base 68 that is positioned on a load-bearing surface. It will be appreciated that the flexible elongate member extends through support members 12, which are therefore preferably hollow. In an alternate embodiment, it will be appreciated that, if planter system 2 is hung from a surface, that support members 12 may be omitted provided that troughs have an alternate method for being secured to flexible elongate member 80.

In the preferred embodiment of FIGS. 11 and 12, planter system 2 includes an optional top most trough 84. In order to water plants in planter inserts 12, a user may merely pour water into top most trough 84. Once the water level is above inlet 24, water will flow down drainage conduit 22 to the next lower trough 10, and subsequently to all lower troughs, as the reservoir in each trough is filled and commences to overflow inlet 24 of the reservoir. It will be appreciated that top most trough need not have an inlet 24 positioned above bottom 31 but may be flush therewith. However, in a particularly preferred embodiment, top most trough 84 is identical with the remaining troughs so that a modular kit may only include one type of trough for simplicity of assembly.

Planter system 2 may also have a lowermost trough 86 that has a drainage conduit 22 and an outlet 26. In such an embodiment, it will be appreciated that a water catch basin (e.g., a bowl or other water tight container) may be provided for receiving any overflow from the reservoir of lowermost trough 86. Alternately, as shown in FIG. 1, the lower most trough may have a sealed bottom so as to sit on a base 68 or other load-bearing surface.

Optionally, as exemplified in FIGS. 11 and 12, drainage conduit 22 may be hidden behind a casing or, alternately, casing 88 may be provided as part of drainage conduit 22. For example, casing 88 may comprise sidewalls that are molded as part of drainage conduit 22 and extend rearwardly therefrom. The sidewalls conform to the profile of the U-shaped channel 56 of planter insert 12 and fit there within. Accordingly, casing 88 provides a continuous surface that abuts U-shaped channel 56 and prevents water, soil or plant debris fall down channel 56 into reservoir 20 or splashing onto wall 78 or onto the floor.

The modular planter system 2 may be adaptable for indoor, outdoor or greenhouse environments. In greenhouses, for example, it may be employed for plant propagation, and enables efficiency in the use of floor space, and efficiency in energy expenditure for lighting and heating due to the vertical alignment of the plants. The invention may also be employed for aesthetic purposes. For example, when the planter inserts 14 are filled, the foliage of the plants may grow to cover the modular planter system 2.

The modular planter system as described may offer versatility in forming spacial arrangements and yet may also be easily assembled into any desired spacial arrangement. Each planter insert may be removed and rotated within its respective trough or moved to another trough, and each individual trough 10 and/or support member 12 may be removed or added to the overall modular planter system as required.

It is to be appreciated that the system may be extended to any desired number and size of planter inserts 14, support members 12 and troughs 10, depending on the amount of planting space that is desired.

It will be appreciated that the use of a wall that at least partially surrounds the water falling towards reservoir 20 of the lower trough 10b to which water is directed by a flow director is that liquid and other materials are much less likely to be deflected away from the next lower trough 10b e.g. by wind or by deflecting off the plants in the next lower trough 10. Thus, water damage to the floor or other surfaces below or around the planter system 2, as well as loss of liquid and other materials from the planter system 2 may be avoided.

It will be understood that no limitation of the scope of the invention is hereby intended. While the invention has been disclosed and described with reference to a limited number of embodiments, those skilled in the art will appreciate that the various modifications, variations and additions to the process may be made, and it is therefore intended in the following claims to cover each such variation, addition and modification as falls within the true spirit and scope of the invention. Such alterations and further modifications in the illustrated device, and such applications of the principals of the invention as is illustrated herein as would normally occur to one skilled in the art to which the invention relates, are considered as included in the invention.

I claim:

1. A modular planter system comprising:
(a) a plurality of vertically spaced apart troughs, each of said troughs having a top, a bottom, a liquid reservoir, and a drainage conduit having an inlet and an outlet, the inlet in flow communication with an upper portion of the liquid reservoir;
(b) at least one longitudinally extending support member adapted to position the troughs one above another whereby a substantially vertically extending series of troughs is provided;
(c) a plurality of planter inserts, each planter insert is configured for insertion into a trough, each planter insert having a top and a bottom that is received in the reservoir of a trough; and,
(d) the plurality of troughs including at least one pair of adjacent troughs, each pair of adjacent troughs comprising an upper trough and a lower trough, the drainage conduit of the upper trough extending downwardly to a position adjacent the top of a planter insert that is positioned in the lower trough.

2. The modular planter system of claim 1 further comprising a flow director positioned to direct liquid exiting the outlet of the drainage conduit of the upper trough away from the inlet of the drainage conduit of the lower trough.

3. The modular planter system of claim 2 wherein the flow director forms part of the drainage conduit of the upper trough.

4. The modular planter system of claim 3 wherein the flow director comprises an exit aperture portion provided at the outlet of the drainage conduit of the upper trough and configured to direct liquid exiting the outlet at least partially laterally.

5. The modular planter system of claim 4 wherein the planter insert positioned in the lower trough includes a wall extending at an angle to the vertical from a position proximate the outlet of the drainage conduit of the upper trough downwardly towards the top of the reservoir of the lower trough.

6. The modular planter system of claim 5 wherein the wall terminates at a position proximate the top of the reservoir of the lower trough.

7. The modular planter system of claim 2 wherein the flow director forms part of the planter insert positioned in the lower trough.

8. The modular planter system of claim 7 wherein the flow director comprises a connecting conduit having an inlet positioned to receive liquid from the drainage conduit of the upper trough and an outlet positioned to direct liquid into the reservoir of the lower trough.

9. The modular planter system of claim 7 wherein the flow director comprises an angled wall positioned to receive liquid from the outlet of the drainage conduit of the upper trough, the wall being at an angle to direct the liquid at least partially laterally.

10. The modular planter system of claim 9 wherein the planter insert positioned in the lower trough includes a wall extending at an angle to the vertical from a position proximate the angled wall downwardly towards the top of the reservoir of the lower trough.

11. The modular planter system of claim 10 wherein the wall terminates at a position proximate the top of the reservoir of the lower trough.

12. The modular planter system of claim 7 wherein the flow director comprises a cap positioned over the inlet of a drainage conduit of the lower trough, the cap having at least one side wall that is at least partially open.

13. The modular planter system of claim 2 wherein the flow director forms part of the at least one support member.

14. The modular planter system of claim 1 wherein the drainage conduits are centrally positioned.

15. The modular planter system of claim 1 wherein the drainage conduits are axially aligned.

16. The modular planter system of claim 1 wherein each trough is of the same construction.

17. The modular planter system of claim 1 wherein a support member is positioned between each pair of adjacent troughs.

18. The modular planter system of claim 1 wherein only one planter insert is received in each trough.

19. The modular planter system of claim 18 wherein each planter insert is of the same construction.

20. The modular planter system of claim 1 wherein the outlet of the drainage conduit of the upper trough is positioned above the inlet of the drainage conduit of the lower trough.

21. The modular planter system of claim 2 wherein the flow director forms part of the liquid reservoir of the lower trough.

22. The modular planter system of claim 21 wherein the flow director comprises a cap positioned over the inlet of a drainage conduit of the lower trough, the cap having at least one side wall that is at least partially open.

23. The modular planter system of claim 13 wherein the flow director comprises an angled wall positioned to receive liquid from the outlet of the drainage conduit of the upper trough, the wall being at an angle to direct the liquid at least partially laterally.

24. The modular planter system of claim 5 wherein the wall forms part of a recessed channel of the planter insert, wherein the recessed channel is configured to receive the at least one support member when the planter insert is positioned in the reservoir of the trough.

25. The modular planter system of claim 17 wherein the support member is hollow and an elongate flexible member extends therethrough, the elongate flexible member having an upper end adapted to be secured to a hanger support.
